(19) United States
(12) Patent Application Publication
(10) Pub. No.: US 2006/0020539 A1
(43) Pub. Date: Jan. 26, 2006

(54) Insurance program method and system for student loans

(76) Inventor: Maurice Michael Salter, Los Angeles, CA (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/153,481

(22) Filed: Jun. 16, 2005

Related U.S. Application Data
(60) Provisional application No. 60/589,834, filed on Jul. 22, 2004.

(51) Int. Cl. G06Q 40/00

(52) U.S. Cl. 705/38

(57) ABSTRACT

Methods and systems are provided for the student loan marketplace that enable third party insurers to participate in the market as forbearance or default bridges. Particularly, insurance is offered to student loan recipients, which cover specified circumstances of non-repayment to the lender. With such insurance coverage, defaults on loans can be reduced as well as preserving the good credit of the borrowers.

### CROSS-REFERENCE TO RELATED APPLICATIONS

This application claims priority to U.S. Provisional Application entitled “INSURANCE PROGRAM FOR STUDENT LOANS,” filed Jul. 22, 2004, having Ser. No. 60/589,834, the disclosure of which is hereby incorporated by reference in its entirety.

### FIELD OF THE INVENTION

The present invention relates generally to systems and methods for insuring student loans. More particularly, the present invention relates to instituting mechanisms for reducing defaults on government-backed or lender-backed student loans using an insurance underwriter.

### BACKGROUND OF THE INVENTION

Loans for student education in the United States market place come from either federally guaranteed student loans offered under the Federal Family Education Loan Program or a private/alternative loan organization. In the former instance, federal student loans are guaranteed by the federal government up to 98% of the defaulted loan balance. Federally authorized guarantors (such as American Student Assistance, Sallie Mae, EdFund) process defaulted student loan payments to lenders. The borrower must demonstrate need and/or have an income sufficiently below a designated threshold to qualify for a federal Stafford undergraduate or graduate student loan or have credit-worthiness to qualify for a federal Parent Loan for Undergraduate Students (PLUS). Federal Stafford student loans have limits—up to $10,000 per academic year for undergraduate Stafford Loans and $18,500 per year for almost all graduate programs except in medicine; PLUS covers the full cost of undergraduate education less other aid received; however, only approximately one-half of these borrowers meet the credit criteria to qualify. Thus, the gap between a federal student loan and the full cost of education is widening and unmet need is a growing issue. Given these requirements, numerous students must resort to obtaining loans from private or alternative loan organizations which are not government or federally guaranteed. Accordingly, loans procured through such agencies typically incur a higher interest rate or shorter term for repayment.

The prevailing interest rates and processing fees, as well as repayment terms, are set July 1 of each year and are based up 90 Day T-Bill rates at the end of May preceding the July 1 rate change. As interest rates are climbing, the rates on student loans rise commensurately. All loans, federal or private, are also dependent upon the default rate. Default is understood to occur when the borrower does not make timely payments to the lending agency. Such non-payments may occur from work lay-off, unemployment, illness, relocation, unpaid leaves of absence, or other events that precipitate a reduction of the borrower's income.

A defaulted loan has major credit implications for the borrower, since these loans are not dischargeable in bankruptcies. Furthermore, default rates impact all participants in the federal and private student loan marketplace. Institutions find it more difficult to find lenders who are willing to lend to their students and receive lower ratings in quality rankings (e.g. U.S. News and World Report), borrowers, as noted, have negative credit issues, lenders face loan portfolio devaluations, guarantors are compensated based upon lowering default rates, and the federal government or private lender suffer losses. There are forbearance and deferment options for federal student loans and many private student loans; however, interest on these loans accrues during these time periods, ultimately increasing loan balances. Once these options are utilized, the borrower is confronted with defaulting on his or her loan if payments cannot be made. In essence, conventional student loan mechanisms do not provide a bridge or vehicle for effectively accommodating periods of non-payment by the borrower that give rise to defaults on the loan.

Accordingly, it is desirable to provide methods and systems that provide a financially acceptable bridge for all parties involved in a student loan transaction, which enable the reduction of financial risks for the lending institution and avoidance of bad credit for the borrower in the event of a temporary period of nonpayment of the loan.

### SUMMARY OF THE INVENTION

The foregoing needs are met, to a great extent, by the present invention, wherein in one aspect some embodiments are provided for the student loan marketplace that enable third party insurers to participate in the market as forbearance, deferment or default bridges. Insurance is offered to student loan recipients, which cover specified circumstances of non-repayment to the lender.

In accordance with one embodiment of the present invention, a method is provided for insuring a borrower having a student loan to make student loan payments in the event the borrower is unable to make student loan payments, the method comprising the steps of, making student loan insurance available to a borrower with a student loan, insuring the student loan against student loan payment-affecting defined occurrences, charging the borrower an insurance fee, and enabling student loan payments for the borrower in the event of a defined occurrence.

In accordance with another embodiment of the present invention, a computerized system is provided for insuring a borrower having a student loan to make student loan payments in the event the borrower is unable to make student loan payments, the system comprising, a computer, a student loan insurance processing program running on the computer, wherein the processing program facilitates a menu of insurance provider options to the borrower comprising the steps of, making student loan insurance available to the borrower with a student loan, facilitating the insurance of the student loan against student loan payment-affecting defined occurrences, facilitating the charging of the borrower an insurance fee, and facilitating the initiation of student loan payments for the borrower in the event of a defined occurrence.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a block diagram illustrating the relationship between parties in an exemplary embodiment according to this invention.

FIG. 2 is a block diagram illustration another exemplary embodiment according to this invention.

FIG. 3 is a block diagram illustrating another exemplary embodiment.

FIG. 4 is a block diagram illustrating another exemplary embodiment.

FIG. 5. is a block diagram illustrating another exemplary embodiment.

FIG. 6. is a block diagram illustrating another exemplary embodiment.

FIG. 7. is an illustration of a web-based implementation according to the invention.

### DETAILED DESCRIPTION

The invention will now be described with reference to the drawing figures, in which like reference numerals refer to like parts throughout. An embodiment in accordance with the present invention provides qualified student loan borrowers to keep loan payments and interest current in the event of a potential default by the borrower.

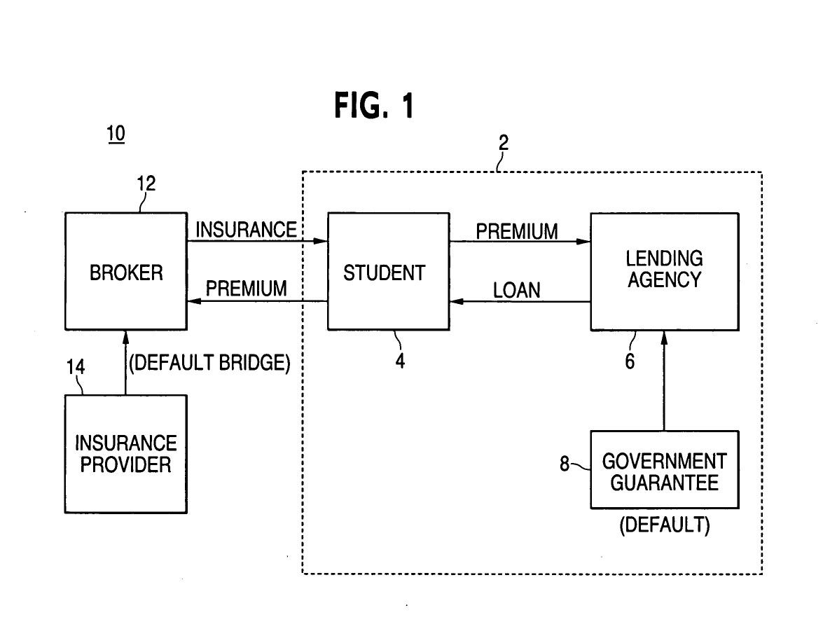

FIG. 1 is a block diagram illustrating an exemplary relationship 10 between parties in a government guaranteed student loan. The exemplary relationship 10 contains a student 4, lending agency 6, government 8, broker 12 and insurance provider 14. Student 4, depending on the arrangements made with the lending agency 6, may be an institution, for example, a university or school that is the recipient of the loan. Lending agency 6, upon proper approval of a loan to the student/institution 4 provides funds for the student 4. In return for the lump sum forwarded by the lending agency 6, the student 4 reciprocates with premiums or payments at designated intervals according to the terms of the lending contract devised between the lending agency 6 and the student 4. In order to mitigate defaults by the student 4, and to reduce the risks (and attendant interest charged to the student 4), the government 8 (e.g., U.S.) provides default insurance up to 98% of the qualifying borrowed monies dispersed to the student 4.

The above arrangements of the student 4, the lending agency 6, and the government 8 constitute a conventional approach to government insured loans to students 4. Once the student 4 receives approval of a loan, and upon the completion of his schooling, the student 4 is required to make a regularly interval payments to lending agency 6 or a proxy thereof. In the event that the student 4 is unable to provide repayment at the regularly scheduled intervals, the student 4 must exhaust all deferment and forbearance options before resorting to a claim of default on the loan. By defaulting on the loan, the student 4 jeopardizes his future credit and also effects the portfolio value of the lending agency 6.

As it is apparent from the above description, the conventional paradigm (illustrated in FIG. 1 by the entities enclosed in the dashed line 2) does not accommodate or allow alternative repayment options in the event that the student 4 has experienced a work layoff, unemployment, illness, relocation or unpaid leaves of absence which prevent the timely and regular repayment of the loaned monies. An exemplary approach to mitigating the above circumstances is to have a broker 12 contract with a major insurance provide 14 or multiple insurance providers 14 to offer a unique program for the student 4 to insure his student loans against occurrences such as work layoff, unemployment, illness, relocation, or unpaid leaves of absence, etc. Such an insurance program will enable a student 4 to have loan payments made by the insurer for a fixed period of time. This insurance will enable insured students 4 to avoid deferment or forbearance during these temporary loan non-payment periods. By providing this second tier insurance program to students 4, colleges and universities can keep down their default rate by encouraging their students 4 to have insurance protection. This, in turn, lowers default statistics for the institution, which helps their ranking and access to federal and or private funds. Lending agencies 6 whose loans are additionally protected by the insurance provider 14 are by benefited by having lower default rates, and therefore, higher profitability.

The exemplary insurance program provided by the broker 12, which is guaranteed by the insurance provider 14, enables borrowers such as the student 4 from avoiding the use of their final options before going into default. The exemplary insurance program in many instances is similar to an indenture. The insurance provider 14 underwrites the broker 12 actual claims which are reflected in the premiums paid by the broker 12 to the insurance provider 14. For example, if there is an actual claim of $500,000.00, then the annual premium will be some fraction of this amount plus some administrative costs for handling the claims. These premiums are paid from the broker 12 to the insurance provider 14. The student 4 can be offered the insurance option when his loan funds or can take out the policy at any time while he has the loan. The student 4 can cancel the insurance option at the end of any period, for example, 12 months.

To take out the insurance policy as part of the loan with the student 4, the lending agency 6 can offer an added borrower benefit. For example, a repayment interest repayment rate reduction would be available for the student 4 who purchases insurance with the loan. In order to recoup the premiums paid from the broker 12 the insurance provider 14, the broker 12 charges the student 4 a monthly insurance fee based on the loan balance and loan term, for example. Other loan conditions or borrowing conditions may also affect the monthly insurance fee paid by the student 4 to the broker 12. The monthly insurance fee can be added to the student 4 servicing invoice (e.g., billed along with the student loan payment by services), or paid outside the service for a non-participating service. The lending agency 6 portfolio will be enhanced with the insurance policy in the bond market, so that the lending agency 6 portfolio value will significantly increase. Other secondary markets are available where the lending agency or insurance holding insurance providers 14 can sell their policies.

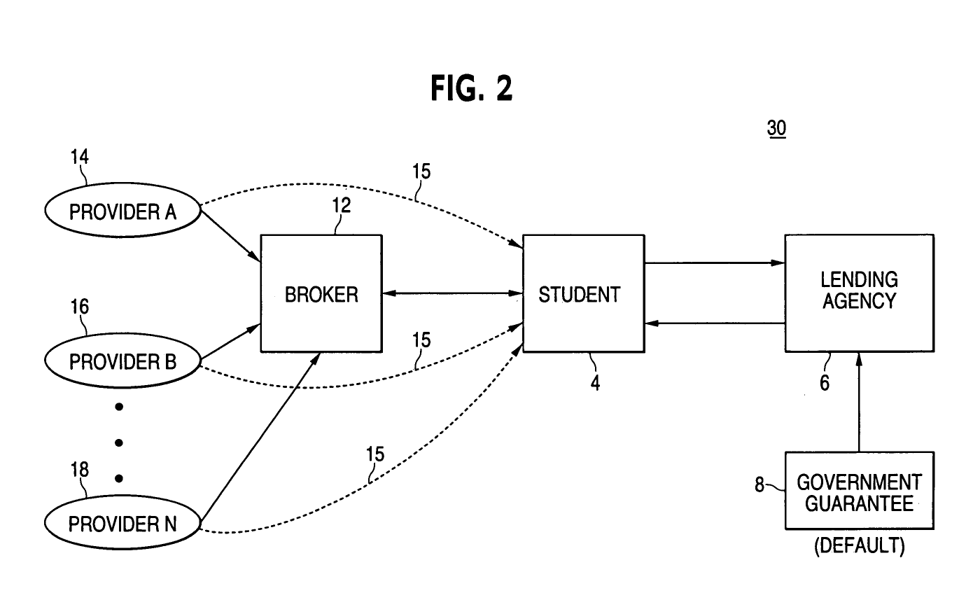

FIG. 2 is a block diagram illustrating another exemplary relationship 30. The exemplary embodiment shown in FIG. 2 differs from the exemplary embodiment shown in FIG. 1, principally in that multiple insurance providers 14, 16, 18 are used. The use of multiple insurance providers 14, 16, 18 enables a distribution of the risk to the providers and also increases the insurance pool and choices offered by the broker 12 to the student 4. The broker 12 can operate as an initiator of the insurance transaction between the insurance providers 14, 16, 18 to the student 4. As an initiator, the broker 12 facilitates the initial transaction arrangement between the insurance providers 14, 16, 18 and the student 4. Based on its initiation role, the broker 12, similar to a mortgage broker, operates as a middle man providing a suite of options, insurance plans to the student 4. In turn, the student 4 can pick and choose individually among the insurance providers 14, 16, 18 or may pick an aggregate insurance plan from the pool of plans offered by the broker 12. As an initiator, the broker 12 does not necessarily engage himself in subsequent transactions or relationships between the student 4 selected plan of the insurance providers 14, 16, 18. Subsequent activity between the selected plan members and the student 4 is indicated by the dashed line 15.

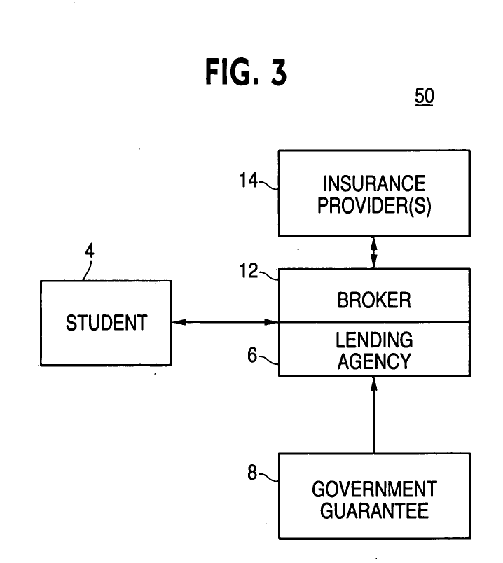

FIG. 3 is a block diagram illustrating another exemplary embodiment wherein the broker 12 operates as part of the lending agency 6 or as an adjunct to the services provided by the lending agency 6 to the student 4. The relationship depicted in FIG. 3 is one where the original loan or monies lent to the student 4 is provided with the third party insurance. That is, rather than offering the student 4 the option of having insurance “after” he has received an initial loan from the lending agency 6, the exemplary embodiment shown in FIG. 3 provides the insurance as being an option available to the student 4 upon his initial request for monies from the lending agency 6. In this example, the lending agency 6 may of its own preferably offer insurance similar to or competing with the insurance offered by the insurance providers 14. With the broker 12 operating as a partner to the lending agency 6, in the conception of the loan to the student 4, the insurance can be offered.

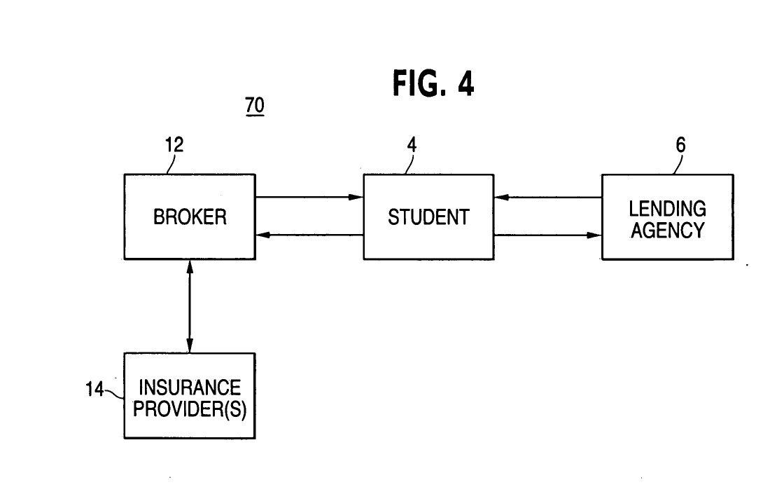

FIG. 4 is a block diagram 70 illustrating an exemplary relationship without a government guarantor. The block diagram 70 is similar to the exemplary embodiment illustrated in FIG. 1. The lending agency 6 can operate as a private lender or as a broker 12 for other private lending institutions, for example, banks, investors, etc. The operation of the broker 12 and the insurance provider 14, as discussed in FIG. 1, are similarly provided to the student 4.

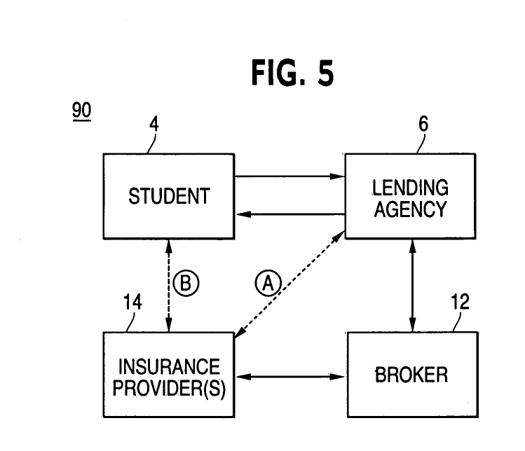

FIG. 5 is a block diagram illustrating another exemplary relationship 90. In FIG. 5, the broker 12 operates as an initiator of insurance options to the lending agency 6. That is, the broker 12 can contact or facilitate the involvement of insurance providers 14 with the lending agency 6 either directly through the broker 12 or as a third party through dashed pathway A. Alternatively, the broker 12 can arrange the negotiations or product offered by the lending agency 6 to the student 4 in such a manner that the insurance provider 14 directly contacts or receives premiums from the student 4. This latter flow of contact and monies is illustrated in FIG. 5 by the dashed pathway B. Accordingly, according to the exemplary embodiment shown in FIG. 5, the insurance provider 14 can either have a direct or indirect mechanism for engaging with the student 4.

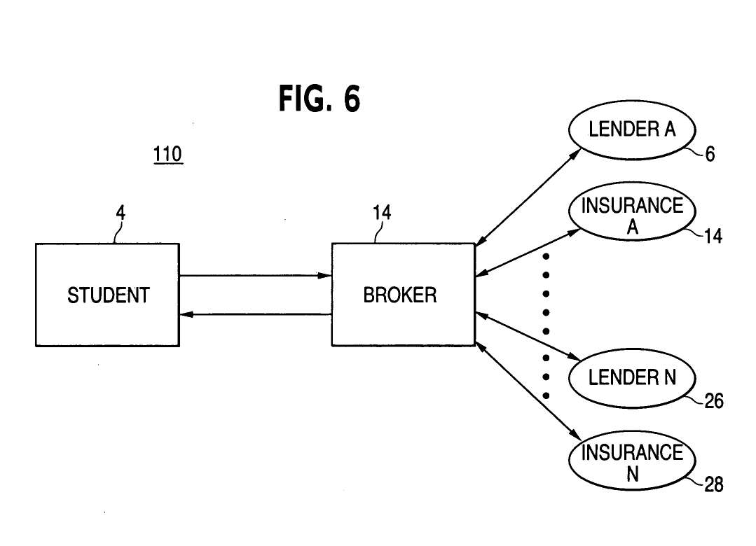

FIG. 6 is a block diagram illustrating another exemplary relationship 110. FIG. 6 details an arrangement between the parties that is similar to the exemplary embodiment shown in FIG. 2, in that multiple providers 6, 14, 26 and 28 are capable of providing services via the broker 12 to the student 4. However, in this exemplary embodiment 110, the broker 12 operates as a middle man providing either individual or packaged loans to the student 4. In one example, the broker 14 can arranged for lender A 6 and insurance provider A 14 to provide a combined loan and a default insurance package for the student 4. Alternatively, the broker 14 can provide a different pallet of lender/insurance programs to the student 4, using other combinations of lender N 26 and insurance provider N 28, for example. Thus as “middle man,” the broker 14 can operate as a third party competitor to other options available to a student 4.

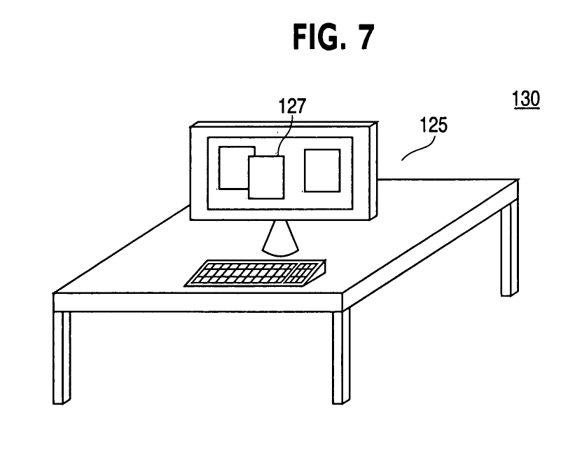

FIG. 7 is an illustration of a web-assessable system 130 utilizing the various exemplary methods described herein. The web-assessable system 130 contains a computer 125 running a web-assessable program 127, for use by a student 4. The web-assessable program 127 can be configured to operate in a matter similar to conventional web-based programs, which require the querying and input of information from a student 4. Having understood the various exemplary embodiments described herein, one of ordinary skill in the art can devise web-accessible programs that implement the processes and systems described to facilitate the convenient processing of student requests with brokers or insurers. Therefore, details regarding the programming and setup of such systems are not provided herein.

By implementation of the various exemplary embodiments describe herein, student/borrower 4 can be availed of a variety of options herethereto currently unavailable. That is, due to the reduced risk of default through the intervention of an insurance provider, lending agencies or the like can lend to a wider audience, resulting in a larger body of students/borrowers able to take out loans, and also potentially qualify to take out larger loans. Additionally, with the reduced risk of default, more lending institutions may enter the student/borrower loan market, resulting in increased competition and better products for the student 4.

It should be appreciated that the various aspects of the invention described in the context of the various figures, herein, may be combined to create hybrid systems and methods for providing insurance coverage for borrowers. That is, certain components and relationships and parties may be switched or reconfigured to provide alternative options and features for the various parties. Accordingly, modifications to the embodiments described herein may be made without departing from the spirit and scope of this invention.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed:

1. A method for insuring a borrower having a student loan to make student loan payments in the event the borrower is unable to make student loan payments, the method comprising the steps of:
making student loan insurance available to a borrower with a student loan;
insuring the student loan against student loan payment-affecting defined occurrences;
charging the borrower an insurance fee; and
enabling student loan payments for the borrower in the event of a defined occurrence.

2. The method as recited in claim 1, wherein the defined occurrences comprise any one or more of work layoff, unemployment, illness, relocation, or unpaid leave of absence.

3. The method as recited in claim 1, wherein the insurance fee is paid on a monthly basis.

4. The method as recited in claim 1, wherein the step of charging a borrower an insurance fee further comprises charging the insurance fee based on a one year time period.

5. The method as recited in claim 1, wherein the step of charging the borrower an insurance fee further comprises a reduction in a student loan interest rate.

6. The method as recited in claim 1, wherein the step of enabling student loan payments for the borrower includes payments from an insurance provider.

7. The method as recited in claim 6, wherein the payments from the insurance provider are paid to a student loan lender.

8. The method as recited in claim 6, wherein the payments from the insurance provider is from a third-party insurance provider.

9. The method as recited in claim 1, wherein the step of enabling student loan payments for the borrower includes payments from a broker making the student loan payments available.

10. The method as recited in claim 1, wherein the student loan is government guaranteed.

11. The method as recited in claim 1, wherein an entity facilitating the step of making student loan insurance available also facilitates the step of insuring the student loan.

12. The method as recited in claim 1, further comprising the step of providing student loan insurance from a plurality of insurance providers.

13. The method as recited in claim 12, further comprising the step of selecting a preferred student loan insurance from the plurality of insurance providers.

14. A computerized system for insuring a borrower having a student loan to make student loan payments in the event the borrower is unable to make student loan payments, the system comprising:
a computer;
a student loan insurance processing program running on the computer, wherein the processing program facilitates a menu of insurance provider options to the borrower comprising the steps of:
making student loan insurance available to the borrower with a student loan;
facilitating the insurance of the student loan against student loan payment-affecting defined occurrences;
facilitating the charging of the borrower an insurance fee; and
facilitating the initiation of student loan payments for the borrower in the event of a defined occurrence.

15. The system as recited in claim 14, wherein the computer is connected to the Internet.

16. The system as recited in claim 15, wherein the processing program is resident on a server computer.

17. The system as recited in claim 14, wherein the defined occurrences comprise any one or more of work layoff, unemployment, illness, relocation, or unpaid leave of absence.

18. The method as recited in claim 14, wherein the student loan is government guaranteed.

19. The method as recited in claim 14, further comprising the step of providing student loan insurance from a plurality of insurance providers.

20. The method as recited in claim 19, further comprising the step of selecting a preferred student loan insurance from the plurality of insurance providers.
